(19) United States
(12) Patent Application Publication
(10) Pub. No.: US 2008/0305976 A1
(43) Pub. Date: Dec. 11, 2008

(54) Color-Stabilization of Aromachemicals

(75) Inventor: Luca Turin, London (GB)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Flexitral, Inc., Chantilly, VA (US)

(21) Appl. No.: 11/997,234

(22) PCT Filed: Jun. 13, 2006
(86) PCT No.: PCT/US2006/022838

§ 371 Date: Jul. 3, 2008

Related U.S. Application Data
(60) Provisional application No. 60/703,443, filed on Jul. 29, 2005.
(60) Provisional application No. 60/722,993, filed on Oct. 4, 2005.
(60) Provisional application No. 60/777,518, filed on Mar. 1, 2006.
(60) Provisional application No. 60/792,627, filed on Apr. 18, 2006.
(60) Provisional application No. 60/793,255, filed on Apr. 20, 2006.

(51) Int. Cl. C11D 3/50; C11D 9/44

(52) U.S. Cl. 510/102

(57) ABSTRACT

The use of at least one water-soluble sulfiting agent to reduce or prevent the discoloration of an aromachemical, odorant, flavorant or perfume component susceptible to discoloration.

### FIELD OF THE INVENTION

The present invention relates to stabilizing compositions containing aromachemical, flavorant, odorant or perfume components, and particularly detergent compositions such as personal cleansing compositions, against discoloration.

### BACKGROUND OF THE INVENTION

Fragrances such as perfumes are often added directly to personal cleansing compositions, such as bar soaps. There are, however, several disadvantages when perfumes are mixed as neat oils into the products. One problem is that some perfume ingredients are not stable in the soap matrix and thus are subject to damage and/or loss. They can also undergo an oxidative or other chemical reaction (e.g., by oxygen, light, heat etc.) and cause undesired discoloration of the products containing them, usually darkening and/or browning.

The smell of vanilla, as exemplified by the synthetic materials vanillin and ethyl vanillin, is one of the most desirable and popular odor characters in the perfumer's palette. While vanillin and its derivatives have been extensively used in liquid perfumery for over a century, their use in soap has always proved problematic; the reason being that vanillin and its derivatives rapidly form highly colored substances thought to be polyphenols in soap and other detergent products under the combined action of light and the alkaline conditions often prevailing in most soap and detergent bases [see U.S. Pat. No. 4,435,601 and Ono Suparno et al, Journal of Chemical Technology & Biotechnology, Volume 80, Issue 1, Pages 44-49]. Consequently, the soap rapidly discolors, going in a matter of hours from white to yellow, and in a matter of days through all the shades of brown to almost black.

Many remedies have been sought for the problem of vanillin discoloration in soap: 1) reduction of the color by using more potent, and therefore less concentrated derivatives of vanillin such as ethylvanillin, 2) addition of dyes to the soap to mask the discoloration, and 3) synthesis of nondiscoloring derivatives of vanillin. Chief among the latter are Isobutavan®, the isobutyrate ester of vanillin, vanillin propylene glycol acetal and Ultravanil®. Neither is ideal, in that the odor character is either different or weaker than that of vanillin and ethylvanillin proper. In general terms, it can be said that structural modifications of the core vanilla molecule always change the odor character in an undesirable direction. The same is true for the flavorant properties of vanillin and ethyl vanillin when the core structures thereof are modified.

It is an object of the invention to provide novel methods for stabilizing flavor, aromachemical, perfume or odorant components against discoloration, in particular those aromachemical, flavor, perfume or odorant components that are susceptible to discoloration as a result of their being converted to undesirable polymers and/or reaction products such as polyphenols, as well as the color-stabilization of compositions, preparations, formulations and articles containing the aromachemicals, odorants, flavorants and perfumes.

It is a further object of the invention to provide color-stabilized aromachemicals, flavors, perfumes or odorants as well as color-stabilized compositions, preparations, formulations and articles containing the aforesaid flavors, aromachemicals, perfumes or odorants.

It is an additional object of the invention to provide uses of a color-stabilizing agent for the color-stabilization of a flavor, aromachemical, perfume or odorant component against discoloration, in particular those flavor, perfume or odorant components that are susceptible to discoloration as a result of their being converted to undesirable polymers and/or reaction products such as polyphenols.

It is a still further object of the invention to provide uses of a color-stabilizing agent for the color-stabilization of a composition, preparation, formulation or article containing an aromachemical, flavor, perfume or odorant component subject to discoloration, in particular those flavor, perfume or odorant components that are susceptible to discoloration as a result of their being converted to undesirable polymers and/or reaction products such as polyphenols.

It is another object of the invention to provide compositions adapted for the color-stabilization of aromachemical, flavor, perfume or odorant components against discoloration, in particular those flavor, perfume or odorant components that are susceptible to discoloration as a result of their being converted to undesirable polymers and/or reaction products such as polyphenols, as well as the color-stabilization of compositions, preparations, formulations and articles containing the aromachemicals, odorants, flavorants and perfumes.

### SUMMARY OF THE INVENTION

The above and other objects are realized by the present invention, one embodiment of which relates to the use of a water-soluble sulfiting agent to reduce or prevent the discoloration of an aromachemical, odorant, flavorant or perfume component subject to discoloration, in particular, a component that is susceptible to discoloration as a result of its being converted to undesirable polymers and/or reaction products such as polyphenols.

A second embodiment of the invention concerns the use of a water-soluble sulfiting agent to reduce or prevent the discoloration of a composition, preparation, formulation or article containing one or more of the aforesaid aromachemical, odorant, flavorant or perfume components.

A third embodiment of the invention relates to a composition comprising an aromachemical, odorant, flavorant or perfume component subject to discoloration, in particular, a component that is susceptible to discoloration as a result of its being converted to undesirable polymers and/or reaction products such as polyphenols and an amount of a water-soluble sulfiting agent effective to stabilize the component against discoloration.

A fourth embodiment of the invention is a composition, preparation, formulation or article containing an aromachemical, odorant, flavorant or perfume component subject to discoloration, in particular, a component that is susceptible to discoloration as a result of its being converted to undesirable polymers and/or reaction products such as polyphenols and an amount of a water-soluble sulfiting agent effective to stabilize the composition, preparation, formulation or article against discoloration.

A fifth embodiment of the invention comprises a method for color-stabilizing an aromachemical, odorant, flavorant or perfume that is subject to discoloration, in particular, a component that is susceptible to discoloration as a result of its being converted to undesirable polymers and/or reaction products such as polyphenols, the method comprising combining with the aromachemical, odorant, flavorant or perfume an amount of water-soluble sulfiting agent sufficient to at least substantially reduce the discoloration thereof.

A sixth embodiment of the invention comprises a method for color-stabilizing a composition, preparation, formulation or article against discoloration, the composition, formulation, preparation or article containing an aromachemical, odorant, flavorant or perfume component that is subject to discoloration, in particular, a component that is susceptible to discoloration as a result of its being converted to undesirable polymers and/or reaction products such as polyphenols, the method comprising combining with the composition, formulation, preparation or article an amount of water-soluble sulfiting agent sufficient to at least substantially reduce the discoloration thereof.

A seventh embodiment of the invention relates to a composition adapted for the color-stabilization of an aromachemical, odorant, flavorant or perfume that is subject to discoloration, in particular, one that is susceptible to discoloration as a result of its being converted to undesirable polymers and/or reaction products such as polyphenols, the composition comprising an amount of a water-soluble sulfiting agent effective to at least substantially reduce the discoloration of the aromachemical, odorant, flavorant or perfume; the composition also comprising a suitable carrier for the sulfiting agent.

An eighth embodiment of the invention concerns a composition adapted for the color-stabilization of a composition, preparation, formulation or article containing an aromachemical, odorant, flavorant or perfume that is subject to discoloration, in particular, one that is susceptible to discoloration as a result of its being converted to undesirable polymers and/or reaction products such as polyphenols, the composition comprising an amount of a water-soluble sulfiting agent effective to at least substantially reduce the discoloration of the composition, preparation, formulation or article; the composition also comprising a suitable carrier for the sulfiting agent.

A ninth embodiment of the invention relates to a kit comprising separately packaged (1) aromachemical, odorant, flavorant, perfume component or mixtures thereof and (2) a water-soluble sulfiting agent in an amount sufficient to color-stabilize the component, either where the component is utilized alone or as an ingredient in a composition, preparation, formulation or article.

A tenth embodiment of the invention comprises an article of manufacture comprising packaging material and a water-soluble sulfiting agent contained within said packaging material, wherein the sulfiting agent is effective for the color-stabilization of an aromachemical, odorant, flavorant or perfume that is subject to discoloration, in particular, one that is susceptible to discoloration as a result of its being converted to undesirable polymers and/or reaction products such as polyphenols, or a composition, preparation, formulation or article containing the aromachemical, odorant, flavorant or perfume and wherein the packaging material comprises a label which indicates that the sulfiting agent is useful for such color-stabilization.

### BRIEF DESCRIPTION OF THE DRAWINGS

FIG. 1 shows a soap bar 3 weeks after its formation, the soap bar containing 5% by weight of the sodium hydrogen sulfite adduct of vanillin (Vanisal® (sodium).

FIG. 2 shows a soap bar 3 weeks after its formation, the soap bar containing 1% by weight of the sodium hydrogen sulfite adduct of ethyl vanillin (Et-Vanisal® sodium).

FIG. 3 shows a soap bar 3 weeks after its formation, the soap bar containing 1% by weight of sodium hydrogen sulfite and 5% by weight of vanillin.

FIG. 4 shows a soap bar 3 weeks after its formation, the soap bar containing 1% by weight of sodium hydrogen sulfite and 1% by weight of ethylvanillin.

FIG. 5 shows a soap bar 3 weeks after its formation, the soap bar containing 5% by weight of vanillin in the absence of a sulfiting agent.

FIG. 6 shows a soap bar 3 weeks after its formation, the soap bar containing 1% by weight of ethylvanillin in the absence of a sulfiting agent.

### DETAILED DESCRIPTION OF THE INVENTION

The present invention is predicated on the discovery that water-soluble sulfites, when employed in certain amounts, act to color stabilize aromachemicals, odorants, flavorants and perfumes that are subject to discoloration. Most unobviously and unpredictably, it has been unexpectedly found that the invention is particularly effective for the color-stabilization of aromachemicals, odorants, flavorants or perfumes that are susceptible to discoloration as a result of their being converted to undesirable polymers and/or reaction products such as polyphenols.

Hereinafter, the term “aromachemical” is used to indicate either an aromachemical, odorant, flavor or perfume component. The term “aromachemical” will be understood to refer to an aromachemical, odorant, flavor or perfume component that is susceptible to discoloration.

The term, “preferred aromachemical” will be understood to refer to an aromachemical, odorant, flavorant or perfume that is susceptible to discoloration as a result of conversion to undesirable polymers and/or reaction products such as polyphenols.

The term “sulfiting agent” is used herein to define compounds that liberate sulfur dioxide under certain conditions (Taylor, Higley and Bush, 1986, Adv. Food Res. 30:1-76). The term, “water-soluble sulfiting agent”, includes, but is not limited to, water-soluble sulfites, bisulfites, hydrosulfites, metabisulfites and sulfur dioxide. Included, for example, are ammonium or alkali metal, particularly sodium or potassium sulfites, bisulfites, hydrosulfites and metabisulfites. Particularly preferred sulfiting agents are sodium metabisulfite, sodium sulfite, sodium bisulfite and sodium hydrosulfite, potassium sulfite, potassium bisulfite, potassium hydrosulfite and potassium metabisulfite, ammonium sulfite and ammonium bisulfite and sulfur dioxide. Sulfites and metabisulfites of alkaline earth metals such as calcium and barium may also be used. The safety of many of these compounds for use in applications such as cosmetic products has been heretofore confirmed [see, e.g., International Journal of Toxicology, 22 (Suppl. 2): 63-88, 2003].

The term “sulfiting agent”, as used herein, is also intended to include adducts of an aromachemical and a sulfite containing compound which is susceptible to a reversible reaction in solution to generate the sulfiting agent and the original aromachemical; hydrates of the sulfiting agent as well as any other derivative, complex or substance that liberates the sulfiting agent in the environment of use. An adduct of an aromachemical containing an aldehyde group can be obtained by the reaction of the aldehyde with a sulfite. Any suitable sulfite such as an alkali metal bisulfite (e.g., sodium bisulfite) may be used in this reaction. The reversible reaction of an aldehyde with a sulfite to form an adduct is a well-known reaction and has been used to extract desirable aldehydes into an aqueous phase from an oily phase. Indeed, it has been used in a variety of industrial processes to extract vanillin (see for example U.S. Pat. No. 4,898,990).

The reaction can be summarized as follows:

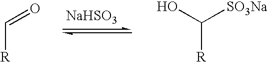

For the purposes of this invention, R is the residue of an aldehyde-containing aromachemical as defined earlier herein. Preferably, R is the residue of an aromachemical comprising a phenol ring such as vanillin or ethyl vanillin or the residue of an indole group containing aromachemical such as heliotropine or Helionol®.

The vanillin adduct of sulfite is benzenemethanesulfonic acid, alpha, 4-dihydroxy-3-methoxy-, ion (1-) (CAS no. 93487-14-0). This compound is the subject of a paper entitled “Thermodynamics of the formation of molecular complexes in the p-vanillin-s” by Bogolitsyn et al, in Koksnes Kim, 1984(4), pages 76-9 (ISSN: 0201-7474). This document describes in some detail the thermodynamics of the reaction between vanillin and sulfites to form the adduct of formula:

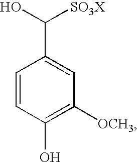

wherein X is any suitable counterion, including the counterions of the sulfiting agents as defined earlier herein. The adduct made from vanillin with sodium containing sulfites will be referred to herein as Vanisal® and the corresponding adduct made from ethylvanillin will be referred to herein as ethyl Vanisal (or Et-Vanisal® or Et-Vanisal® sodium). Corresponding nomenclature will be used to refer to other adducts as appropriate.

Vanisal sodium can be produced by adding equimolar amounts of vanillin and sodium hydrogen sulfite to water either at room temperature or under gentle heating up to about 50 to 60° C. The sulfite dissolves immediately and the vanillin dissolves only as the sulfite adduct is formed. The Vanisal sodium product can be recovered by standard methods known in the art such as evaporation or precipitation. Vanisal sodium is a white water-soluble powder with a (relatively) weak odor of vanillin. It dissolves readily in molten soap base at a temperature of about 60 to 80° C.

The invention is particularly adaptable to compositions, preparations, formulations and articles containing the discoloration-susceptible aromachemical wherein the composition, preparation, formulation or article has both hydrophobic and hydrophilic properties. The phrase “having(has) both hydrophobic and hydrophilic properties” is intended to encompass compositions, preparations, formulations or articles of the invention having at least sufficient hydrophobic character to enable the aromachemical which is not soluble in the hydrophilic phase to dissolve and at least sufficient hydrophilic character to enable the water-soluble sulfiting agent to dissolve. Examples of such compositions include, but are not limited to, detergents, soaps, bleaches, flavorings, fragrances, beverages, shampoos, body deodorants, antiperspirants, fabric softeners, all-purpose, household and/or industrial cleaners, candles, perfumes, shower gels, hygiene or hair-care products, air freshener or cosmetic preparations as well as any emulsions such as oil-in-water and water-in-oil emulsions, aqueous gels that contain a hydrophobic material in an amount sufficient to dissolve the aromachemical and lipid based materials, optionally containing a solubilizing agent such as glycol or a soap in an amount sufficient to dissolve the water-soluble sulfiting agent.

The term, “combine”, as used herein, refers to any convenient and appropriate method for contacting the “sulfiting agent” with the “aromachemical” or “composition, formulation, preparation or article” for color-stabilization purposes. The term includes, but is not limited to mixing, melting, spraying and the like.

The term, “color-stabilizing”, as used herein, is intended to mean reducing or preventing discoloration. It will be appreciated that terms such as “color-stabilize” have a meaning consistent with this definition”.

The sulfiting agent is used in an amount such that it at least partially stabilizes the aromachemical and, therefore, any composition containing the aromachemical against discoloration. It will be appreciated that the amount of sulfiting agent required in any particular situation or composition will depend on a number of factors such as the nature of the aromachemical and the nature of the other ingredients of the composition. Typically, the amount of the sulfiting agent may vary from about 0.01 to about 5 mole equivalents based on the amount of the aromachemical in the composition in which it is used, for example from about 0.1 to about 2 mole equivalents based on the amount of the aromachemical, and more preferably from about 0.5 to about 1.5 mole equivalents, such as about 1 mole equivalents based on the amount of aromachemical.

In terms of percentage by weight, the sulfiting agent is preferably used in an amount of from about 0.1 to about 5% by weight of the composition in which it is used, more preferably from about 0.5 to about 3% by weight, still more preferably from about 0.8 to about 2% by weight, for example from about 0.1 to less than 2.0% by weight, e.g., about 1% by weight.

In the present invention, it is typically not necessary to use the sulfiting agent in combination with another reducing agent or anti-oxidant. For example, it is typically not necessary for the sulfiting agent to be used in combination with a material such as sodium hydride, calcium hydride, sodium aluminum hydride, lithium hydride, sodium borohydride, sodium amide, diborane, alkyl and alkoxy aluminum hydrides, alkyl and alkoxy borohydrides, alkyl and alkoxy sodium aluminum hydrides, diimide and mixtures thereof. Thus, the sulfiting agent is typically (but not essentially) the sole agent employed for reducing discoloration of the composition, product or article in which the aromachemical is employed.

The aromachemicals and compositions, formulations, preparations and articles of the invention are preferably substantially free of organic acids having from 1 to 8 carbon atoms, particularly 4 to 8 carbon atoms and salts of such acids, e.g., acetic acid, citric acid, sodium citrate and potassium citrate. By this it is meant that they preferably contain less than 0.1% by weight of the organic acid or salt, e.g., citric acid, sodium citrate or potassium citrate. The aromachemicals and compositions, formulations, preparations and articles of the invention most preferably contain no organic acids having from 4 to 8 carbon atoms or salts of such acids, e.g., citric acid, sodium citrate or potassium citrate.

The pH at which the invention is used, e.g., the pH of the aromachemicals, compositions, preparations, formulations and articles of the invention is not particularly critical. However, a pH of 3 or greater is typically used and the pH is preferably less than about 9.5. If an adduct of the sulfiting agent and the aromachemical is used the pH is preferably above 6 or 7.

The present invention is particularly useful for reducing and/or preventing discoloration of compositions, preparations, formulations and articles containing the preferred aromachemicals. These include, but are not limited to, phenol and/or indole containing aromachemicals. Aromachemicals comprising a phenol ring may also comprise one or more moieties such as a moiety selected from the group consisting of aldehyde, hydroxyl, ether, ester and olefin. These moieties typically contain 6 or fewer carbon atoms. The indole containing aromachemicals may, for example, have one or more straight chain or branched alkyl and/or aldehyde substituents having up to 6 carbon atoms. Examples include, but are not limited to, methyl, ethyl and C(═O)H.

Examples of preferred aromachemicals containing phenol and Indole containing compounds to which the invention is applicable include, but are not limited to, indole, skatole, heliotropine, hydrocinnamaldehyde, alpha-methyl-3,4-(methylenedioxy) (Helional®), vanillin, straight chain or branched C₁ to C₄ alkyl vanillins such as ethyl vanillin, methyl eugenol, methyl salicylate, benzyl salicylate, eugenol, iso-eugenol, methyl iso-eugenol and mixtures thereof.

The manner and order in which the components of the composition are combined is not particularly important. For example, either the aromachemical or the sulfiting agent may be added to the base composition, preparation, formulation or article, preferably one having both hydrophilic and hydrophobic properties before the other one of the aromachemical or the sulfiting agent; or the aromachemical or the sulfiting agent may be added to the base composition simultaneously, with or without premixing of the aromachemical and the sulfiting agent. Alternatively, if the composition contains hydrophobic and hydrophilic components that are mixed together to form the composition, the aromachemical may be added to the hydrophobic component and/or the sulfiting agent may be added to the hydrophilic component before the two components are mixed to form the composition.

Without wishing to be bound by theory, it is hypothesized that the presence of the sulfiting agent in a composition containing a phenol and/or indole containing aromachemical prevents the reaction of that aromachemical to form polyphenols and/or other colored products. As noted above, the vanillins and similar phenol and/or indole containing aromachemicals are subject to conversion, thought to be oxidation, to colored reaction products, often only by the action of light and heat; a reaction that is accelerated by alkaline conditions. In addition to the references cited above, see also www.medicinescomplete.com/mc/excipients/2006/1000309897.htm; http://cira.ornl.gov/documents/vanillin.pdf; cira.ornl.gov/documents/vanillin.pdf; www.epa.gov/dfe/pubs/pwb/ctsa/appc/appc-4.pdf. and Claire Fargues et al, Chemical Engineering & Technology, v. 19, issue 2, pp 127-136. Unexpectedly and unobviously, it has been discovered that the sulfiting agents of the present invention stabilize these types of aromachemicals against such discoloring reactions.

The present invention provides a method for preparing a composition as defined above. This method comprises combining a composition having both hydrophilic and hydrophobic properties and comprising an aromachemical, which is susceptible to discoloration with a water-soluble sulfiting agent as defined above.

This method can be used to produce both liquid and solid compositions. In the case of solid compositions, the water-soluble sulfiting agent is typically added to and mixed with a molten composition comprising the aromachemical and then the molten product is solidified.

As noted above, the sulfiting agent is preferably used in a composition having both hydrophobic and hydrophilic properties, such as a detergent, soap or other cosmetic/personal care or home care composition, and containing a preferred aromachemical, which is susceptible to discoloration, due to conversion to undesirable polymers and/or reaction products; the sulfiting agent drastically reducing the tendency of the aromachemical and composition to discolor.

It will be understood by those skilled in the art that the precise nature and structure of the sulfiting species employable in the present invention will depend in each instance on factors such as the pH of the composition in which it is employed. That is to say that the sulfite species typically exists in an equilibrium between its various possible protonated forms. Accordingly, the nature of the cation of the sulfiting agent is typically immaterial. However, it is preferred to employ alkali metal salts of sulfiting agents (e.g., Na, K, and the like) or simple organic sulfiting agents since they are readily available and are relatively inexpensive.

The present invention can be used in the production of virtually any composition, preparation, formulation or article of manufacture in which an aromachemical which is susceptible to discoloration, in particular a preferred aromachemical, which can result in discoloration of the article, is used. Examples include bleach, detergents, flavorings and fragrances, beverages, including alcoholic beverages, and the like. The present invention can be used in applications like soaps, detergents, shampoos, body deodorants and antiperspirants, solid or liquid detergents for treating textiles, fabric softeners, detergent compositions and/or all-purpose cleaners for cleaning dishes or various surfaces, for both household and industrial use, and candles. Of course, the invention is not limited to the above-mentioned products, as it can also be used in other current perfumery applications, namely the perfuming of soaps and shower gels, hygiene or hair-care products, as well as of body deodorants, air fresheners and cosmetic preparations.

Suitable compositions, preparations, formulations or articles to which the present invention may be applied include, but are not limited to soaps, detergents (such as laundry detergents and the like), personal care products such as deodorants, shampoos and conditioners, fabric softeners, all of which may be liquid or solid, and candles and air-fresheners.

If the composition of the invention is a soap, it may be a transparent soap or non-transparent (i.e., opaque) soap. If the soap is transparent (liquid or solid) it does not contain sodium metabisulfite in an amount of from 0.2 to 0.5% by weight. More preferably, if the soap is transparent the sulfiting agent is not sodium metabisulfite and/or the soap composition does not comprise over 50% by weight of a complex mixture of sodium and triethanolamine salts of a fatty acid or acids having from 6 to 18 carbon atoms and an iodine value of from 8 to 15.

It will, of course, be appreciated that co-ingredients and other aromachemicals in addition to those that are susceptible to discoloration, which can result in discoloration of a composition, product or article, can be included in the compositions to which the present invention is applied. The nature and the variety of these co-ingredients and other aromachemicals do not require a more detailed description here, which, moreover, would not be exhaustive, and the person skilled in the art will be able to choose them through their general knowledge and as a function of the nature of the product to be perfumed and of the desired olfactive or flavor effect.

The present invention can be applied to detergents containing bleaching agents and activators such as, for example, tetraacetylethylenediamine (TAED), hypohalites, in particular hypochlorite, peroxygenated bleaching agents such as, for example, perborates, etc. It can also be used in the production of body deodorants and antiperspirants, for example, those containing aluminum salts.

Preferably, the compositions of the invention do not contain a water insoluble oxidant suspended in the liquid phase.

Although the detergent compositions of the invention may contain any components, which are standard in the detergent art, in one aspect the present invention provides compositions that are substantially free of alkanolamines, (alkyl glycoside)urinates, amine oxides and/or gelatin.

The compositions to which the invention is applied may include a detersive surfactant and optionally, one or more additional detergent ingredients, including materials for assisting or enhancing cleaning performance, treatment of the substrate to be cleaned, or to modify the aesthetics of the detergent composition (e.g., perfumes, colorants, dyes, etc.). Non-limiting examples of synthetic detersive surfactants useful herein typically at levels from about 0.5% to about 90% by weight, include the conventional C1-18 alkyl benzene sulfonates (“LAS”) and primary, branch-chain and random C10-20 alkyl sulfates (“AS”), and the like. Preferred compositions incorporating only synthetic detergents have a detergent level of from about 0.5% to 50%. Compositions containing soap preferably comprise from about 10% to about 90% soap.

The compositions to which the invention is applied can contain other ingredients such as enzymes, bleaches, fabric softening agents, dye transfer inhibitors, suds suppressors, and chelating agents, all well known within the art.

It is well known in the art to include enzymes in detergent products such as laundry products. The present invention can be readily applied to compositions comprising enzymes. However, in one aspect of the invention products that are substantially free of enzymes are provided.

The present invention can also be applied to beverages compositions. The beverage composition can be a cola beverage composition, and can also be coffee, tea, dairy beverage, fruit juice drink, orange drink, lemon-lime drink, beer, malt beverages, or other flavored beverage. The beverages can be in liquid or powdered form. The beverage compositions can also include one or more flavoring agents; artificial colorants; vitamin additives; preservatives; caffeine additives; water; acidulants; thickeners; buffering agents; emulsifiers; and/or fruit juice concentrates.

Artificial colorants that may be used include caramel color, yellow 6 and yellow 5. Useful vitamin additives include vitamin B2, vitamin B6, vitamin B12, vitamin C (ascorbic acid), niacin, pantothenic acid, biotin and folic acid. Suitable preservatives include sodium or potassium benzoate. Salts that may be used include sodium, potassium and magnesium chloride. Exemplary emulsifiers are gum arabic and purity gum, and a useful thickener is pectin.

The beverage may, for example, be a carbonated cola beverage. The pH is generally about 2.8 and the following ingredients can be used to make the syrup for these compositions: Flavor Concentrate, including one or more of the compounds of the invention herein, Phosphoric Acid, Caffeine (1.24 g), and artificial sweetener, sugar or corn syrup (to taste, depending on the actual sweetener). The beverage composition can be prepared, for example, by mixing the foregoing syrup with carbonated water in a proportion of 50 ml syrup to 250 ml of carbonated water.

The invention can also be applied to flavored food and pharmaceutical compositions. The sulfiting agent can be incorporated into conventional foodstuffs using techniques well known to those of skill in the art.

Flavored compositions of the invention may include an orally-deliverable matrix material. The orally-deliverable matrix material can be selected from the group consisting of gums, latex materials, crystallized sugars, amorphous sugars, fondants, nougats, jams, jellies, pastes, powders, dry blends, dehydrated food mixes, baked goods, batters, doughs, tablets, and lozenges.

The present invention can be applied to a flavorless gum base. In one method for producing such gum based products a blade mixer is heated to about 110° F. (about 43 to 44° C.), the gum base is preheated so that it is softened, and the gum base is then added to the mixer and allowed to mix for approximately 30 seconds. The sulfiting agent and the aromachemical (or an adduct of the sulfiting agent and the aromachemical) are then added to the mixer and mixed for a suitable amount of time. The gum can be then removed from the mixer and rolled to stick thickness on waxed paper while warm.

Illustrative examples of compositions, articles and products to which the present invention can be applied are provided below. It will be appreciated that the invention is in no way limited to its use in these types of compositions.

Conditioning shampoos, which may, for example, comprise:

| | |
|---|---|
| Triethanolamine lauryl sulfate | 35.00 |
| Coconut diethanolamide | 2.00% |
| Coco amido propyl betaine 30% | 10.00% |
| Hydrolysed vegetable protein | 1.00% |
| Sodium chloride | qs |
| Lactic acid | to pH 6.0 |
| Perfume, color, preservative | qs |
| Water | to 100 |

Pearlized shampoos, which may, for example, comprise:

| | |
|---|---|
| 64Lanolin ethoxylate | 5.0 |
| Sodium lauryl ether sulfate 50% | 20.0 |
| Alkyl amidopropylbetaine 30% | 7.0 |
| Coconut diethanolamide | 1.5 |
| Ethylene glycol monostearate | 1.0 |
| Sodium chloride | 1.0 |
| Perfume, color, preservative | qs |
| Water | to 100% |

Soluble Bath Fragrances, which may, for example, comprise:

| | |
|---|---|
| Water | 70.0 |
| Sorbitan monolaurate (20EO) | 25.0 |
| Fragrance oil | 5.0 |
| Color, preservative | qs |

Shower Gels, which may, for example, comprise:

| | |
|---|---|
| Water | to 100 |
| Sodium lauryl ether sulfate 30% | 40.0 |
| Coconut diethanolamide | 2.0 |
| Alkyl amido propyl betaine 30% | 5.0 |
| Cocoamine oxide | 2.0 |
| Sodium chloride | 1.0 |
| Perfume, color, preservative | qs |
| Lactic acid | to pH 6.5 |

Roll-on Antiperspirant, which may, for example, comprise:

| | |
|---|---|
| Water | 37.35 |
| Hydroxyethylcellulose | 0.65 |
| Ethanol | 20.00 |
| Polyethoxylated lanolin | 2.00 |
| Aluminum chlorhydrate 50% | 40.00 |
| Perfume, color, preservative | qs |

Cleansing Lotion with Lanolin, which may, for example, comprise:

| | |
|---|---|
| Water | 69.4 |
| Heavy liquid paraffin | 20.0 |
| Cetyl/stearyl alcohol | 11.0 |
| Pure liquid lanolin | 1.0 |
| Sorbitan monostearate (HLB 4.7) | 2.0 |
| Sorbitan monostearate (20EO) (HLB 14.9) | 2.0 |
| Hydroxyethylcellulose | 0.5 |
| Propylene glycol | 14.0 |
| Perfume, preservative | qs |

Toothpaste, which may, for example, comprise:

| | |
|---|---|
| Water | 21.50 |
| Glycerol | 25.00 |
| Sodium carboxymethylcellulose | 1.00 |
| Sodium monofluorophosphate | 0.80 |
| Sodium saccharin | 0.20 |
| Dicalcium phosphate dehydrate | 50.00 |
| Sodium lauryl sulfate | 1.50 |
| Flavor, preservative | qs |

Barrier Cream, which may, for example, comprise:

| | |
|---|---|
| Water | 57.0 |
| Glyceryl monostearate self-emulsifying | 11.0 |
| Cetyl/stearyl alcohol | 2.2 |
| Sodium lauryl sulfate | 0.8 |
| Beeswax | 4.0 |
| Lanolin | 6.0 |
| Glycerol | 4.0 |
| Zinc stearate | 15.0 |
| Perfume, dye, preservative | qs |

Cleansing Beauty Milk, which may, for example, comprise:

| | |
|---|---|
| Water | 16.20 |
| Lanolin alcohol | 11.10 |
| Cetyl alcohol | 10.40 |
| Heavy liquid paraffin | 8.40 |
| Stearic acid | 4.20 |
| Triethanolamine | 2.10 |
| Perfume, color, preservative | qs |

Natural Moisture Cream, which may, for example, comprise:

| | |
|---|---|
| Oil phase | |
| Caprylic/capric triglyceride | 13.0 |
| Octyl cocoate | 3.0 |
| Cetyl esters | 3.0 |
| Cetyl/stearyl alcohol | 13.0 |
| Polysorbate 60 | 3.0 |
| Sorbitan stearate | 2.0 |
| Aqueous phase | |
| Water | 69.0 |
| Glycerol | 3.0 |
| Hydrolysed vegetable protein | 1.0 |
| Perfume, color, preservative | qs |

Aerosol Shaving Foam, which may, for example, comprise:

| | |
|---|---|
| Water | 83.50 |
| Lanolin liquid | 2.00 |
| Myristic acid | 2.00 |
| Stearic acid | 5.00 |
| Liquid paraffin 25cS | 1.00 |
| Propylene glycol | 3.00 |
| Triethanolamine | 3.50 |
| Perfume, preservative | qs |

Dish-wash Liquids, which may, for example, comprise:

| | |
|---|---|
| Water | to 100 |
| Sodium dodecylbenzene sulfonate 60% | 11.70 |
| Coconut diethanolamide | 1.00 |
| Sodium lauryl ether sulfate 27% | 6.60 |
| Sodium chloride | qs |
| Perfume, color, preservative | qs |

Air Freshener Gel, which may, for example, comprise:

| | |
|---|---|
| Water | 87.00 |
| Carrageenan | 3.00 |
| Fragrance oil | 5.00 |
| Hydrogenated caster oil (50EO) | 5.00 |
| Preservative, color | qs |

Cream Hard Surface Cleaner, which may, for example, comprise:

| | |
|---|---|
| Water | 42.90 |
| Dodecylbenzene sulfonic acid | 2.90 |
| Sodium hydroxide 47% | 0.80 |
| Calcium carbonate | 51.30 |
| Sodium carbonate | 2.00 |
| Coconut diethanolamide | 1.00 |
| Perfume, color, preservative | qs |

Thick Acid Toilet Cleaner, which may, for example, comprise:

| | |
|---|---|
| Water | 77.60 |
| Phosphoric acid 85% | 5.90 |
| Hydrochloric acid 37% | 13.50 |
| Hydroxyethyl tallow glycinate 45% | 3.00 |
| Perfume, color | qs |

The present invention may be applied to antiperspirant gel stick compositions such as those described in U.S. Pat. No. 4,781,917. These compositions are substantially free of unbound water and comprise from about 5 to about 50% of a solubilized antiperspirant active, from about 7% to about 35% of intermediate polarity emollients, from about 1% to about 5% of a benzylidene sorbitol, from about 15% to about 75% of a polar solvent, from about 1% to about 20% of a coupling agent and from about 0.5% to about 10% of a buffering agent. In these compositions, the coupling agent is any compound, composition, or combination thereof that acts to bring the polar, intermediate polarity and non-polar components into a homogeneous stick composition, such as dimethyl isosorbide.

Another suitable solid antiperspirant stick composition is described in U.S. Pat. No. 4,725,432. This stick comprising from about 5% to about 20% of a long-chain fatty alcohol having from about 8 to about 18 carbon atoms in its chain; from about 35% to about 55% volatile silicone; and from about 10% to about 70% of an astringent antiperspirant salt; and 1% to about 3% of the total fatty alcohol of an alcohol selected from the group consisting of C₂₀ alcohol, alcohols whose chains are longer than C₂₀ and mixtures thereof.

An anhydrous antiperspirant gel-solid stick composition to which the present invention may be applied is described in U.S. Pat. No. 5,840,288. This antiperspirant gel-stick comprises from about 0.5% to about 60% by weight of a particulate antiperspirant active; from about 1% to about 15% by weight of a solid non-polymeric gallant that is substantially free of organic polymeric gallants, dibenzylidene alditol, inorganic thickening agents, derivatives of n-acyl amino acid, or combinations thereof; from about 10% to about 80% by weight of an anhydrous liquid carrier containing a silicone liquid carrier selected from the group consisting of polyalkylsiloxanes, polyalkyarylsiloxanes, polyestersiloxanes, polyethersiloxane copolymers, polyfluorosiloxanes, polyaminosiloxanes; and combinations thereof. These compositions typically contain less than about 5%, preferably less than about 3%, more preferably less than about 1%, most preferably zero percent, by weight of free or added water, other than the water of hydration typically associated with the particulate antiperspirant active prior to formulation.

An aqueous fabric conditioning composition to which the present invention may be applied is described in U.S. Pat. No. 6,432,911. This fabric conditioning composition comprises (i) one or more cationic surfactants selected from quaternary ammonium compounds having at least one ester group and being formed from a parent fatty acid having a degree of unsaturation represented by an iodine value of from 20 to 140 and; quaternary ammonium compounds having two C8-C28 alkyl or alkenyl chains directly attached to the nitrogen and being formed from a parent fatty acid having a degree of unsaturation represented by an iodine value of from 0 to 20 and (ii) 20 to 45% by weight of one or more oils selected from the group consisting of mineral oils, ester oils, and vegetable oils, (iii) one or more solvents, (iv) perfume. The composition is in the form of a micro-emulsion.

U.S. Pat. No. 4,913,828 describes detergency compositions which may be formulated as fabric detergent compositions, shampoos, hair conditioners and dryer- and washer-added fabric conditioners to which the present invention can be applied. These detergency compositions comprise from about 1% to about 98% of a water-soluble detergent surfactant selected from the group consisting of cationic surfactants, non-ionic surfactants, zwitterionic surfactants, amphoteric surfactants and anionic surfactants and mixtures thereof; from about 0.1% to about 20% of a water-insoluble composite having an average diameter of from about 10 to about 300 microns, comprising (i) from about 1 to about 99% of an alkyl amine-anionic surfactant ion-pair complex having the formula N⁺R₁R₂R₃H A⁻ wherein each R₁ and R₂ independently is C₁₆ to C₂₀ alkyl or alkenyl, R₃ is H or CH₃, and A is an anionic surfactant selected from the group consisting of alkyl sulfonates, aryl sulfonates, alkylaryl sulfonates, alkyl sulfates, dialkyl sulfosuccinates, alkyl oxybenzene sulfonates, acyl isethionates, acylalkyl taurates, olefin sulfonates, alkyl ethoxylated sulfates and paraffin sulfonates, and mixtures of such ion-pair complexes; and (ii) from about 99% to about 1% of nonsilicone wax; and from about 5% to about 50% of a detergency builder other than C₁₀-C₁₈ alkyl monocarboxylic acids or salts thereof.

The sulfiting agent or the adduct of the aromachemical and a sulfite may be added to the compositions described above at any suitable point during the production of the composition. The amounts of the components given in each of these examples are approximate and typically indicate that amount of each component in a composition that does not comprise a sulfiting agent. It will be appreciated that these amounts will vary slightly once a sulfiting agent is added depending on the amount of sulfiting agent added.

### EXAMPLES

### Preparation of Vanisal® Sodium

Equimolar amounts of vanillin and sodium hydrogen sulfite were added to water and stirred at room temperature until the vanillin was completely dissolved. The water was removed under vacuum and the product (Vanisal® sodium) was obtained as a white powder.

### Preparation of Et-Vanisal® Sodium

Equimolar amounts of ethyl vanillin and sodium hydrogen sulfite were added to water and stirred at room temperature until the ethyl vanillin was completely dissolved. The water was removed under vacuum and the product (Ethyl Vanisal® sodium) was obtained as a white powder.

### Example 1

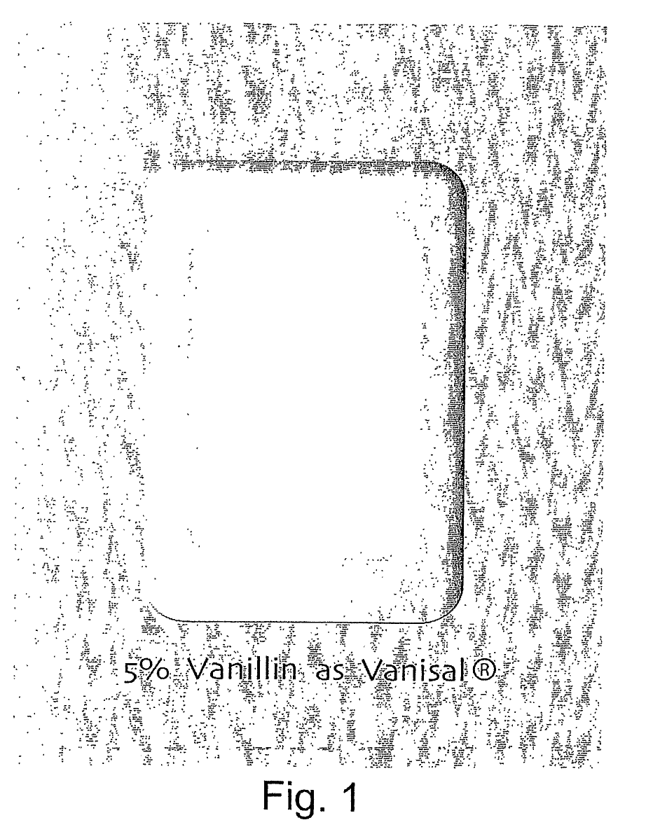

A glycerine soap base (obtained from http://www.meltandpoursupplies.com/bases.htm was melted at about 65° C. The melted soap based was maintained at 60 to 80° C. and 5% by weight of Vanisal® Sodium was added. The mixture was stirred until the Vanisal® Sodium dissolved. The mixture was allowed to cool to room temperature in a mould to produce a soap bar. The soap bar was stored on a shelf at room temperature in a light environment with no protection from the light for three weeks. A photograph of the soap bar after three weeks at room temperature is shown in FIG. 1.

### Example 2

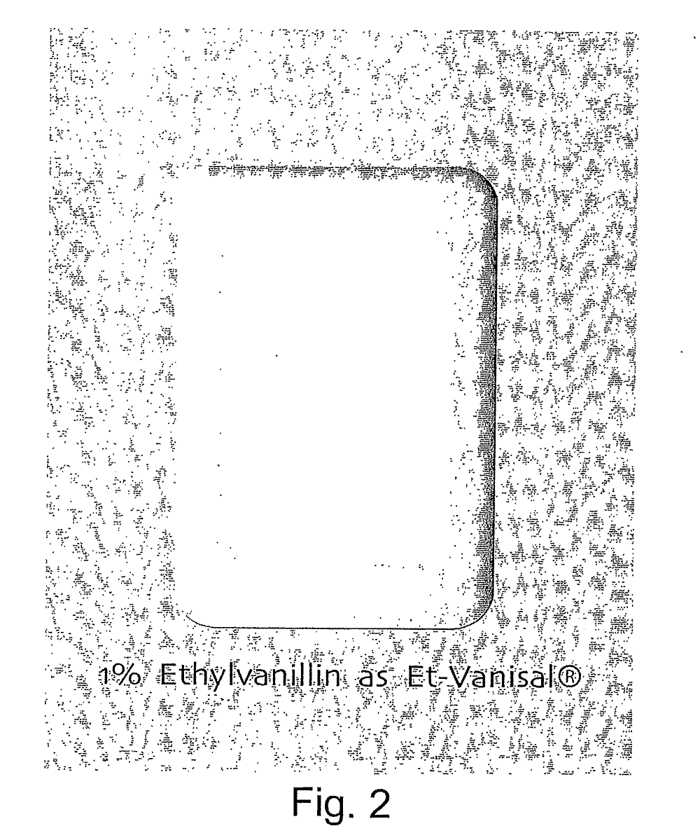

A glycerine soap base (obtained from http://www.meltandpoursupplies.com/bases.htm was melted at about 65° C. The melted soap based was maintained at 60 to 80° C. and 1% by weight of Et-Vanisal® Sodium was added. The mixture was stirred until the Ethyl Vanisal® Sodium dissolved. The mixture was then allowed to cool to room temperature in a mould to produce a soap bar. The soap bar was stored on a shelf at room temperature in a light environment with no protection from the light for three weeks. A photograph of the soap bar after three weeks at room temperature is shown in FIG. 2.

### Example 3

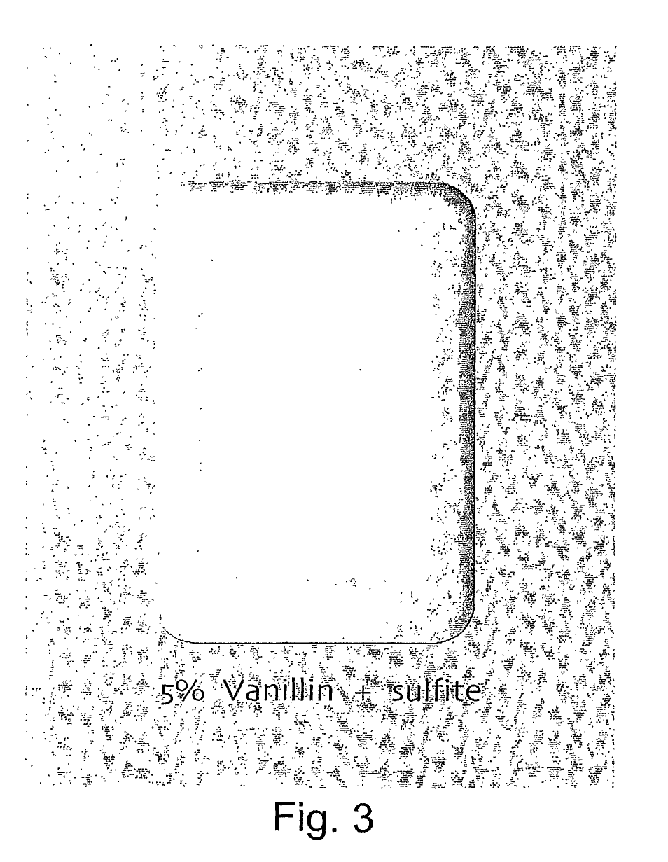

A glycerine soap base (obtained from http://www.meltandpoursupplies.com/bases.htm was melted at about 65° C. The melted soap based was maintained at 60 to 80° C. and 5% by weight of vanillin added. The mixture was stirred until the vanillin dissolved. 1% by weight of sodium hydrogen sulfite was added and the mixture stirred until this had dissolved. The mixture was then allowed to cool to room temperature in a mould to produce a soap bar. The soap bar was stored on a shelf at room temperature in a light environment with no protection from the light for three weeks. A photograph of the soap bar after three weeks at room temperature is shown in FIG. 3.

### Example 4

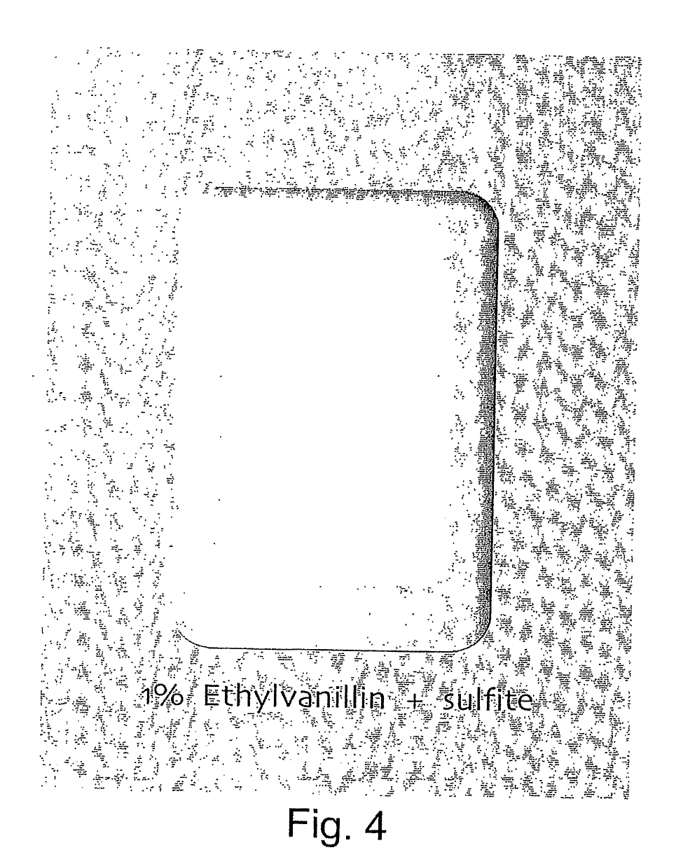

A glycerine soap base (obtained from http://www.meltandpoursupplies.com/bases.htm was melted at about 65° C. The melted soap based was maintained at 60 to 80° C. and 1% by weight of ethylvanillin added. The mixture was stirred until the ethylvanillin dissolved. 1% by weight of sodium hydrogen sulfite was then added and the mixture was stirred until this had dissolved. The mixture was then allowed to cool to room temperature in a mould to produce a soap bar. The soap bar was stored on a shelf at room temperature in a light environment with no protection from the light for three weeks. A photograph of the soap bar after three weeks at room temperature is shown in FIG. 4.

### Comparative Example A

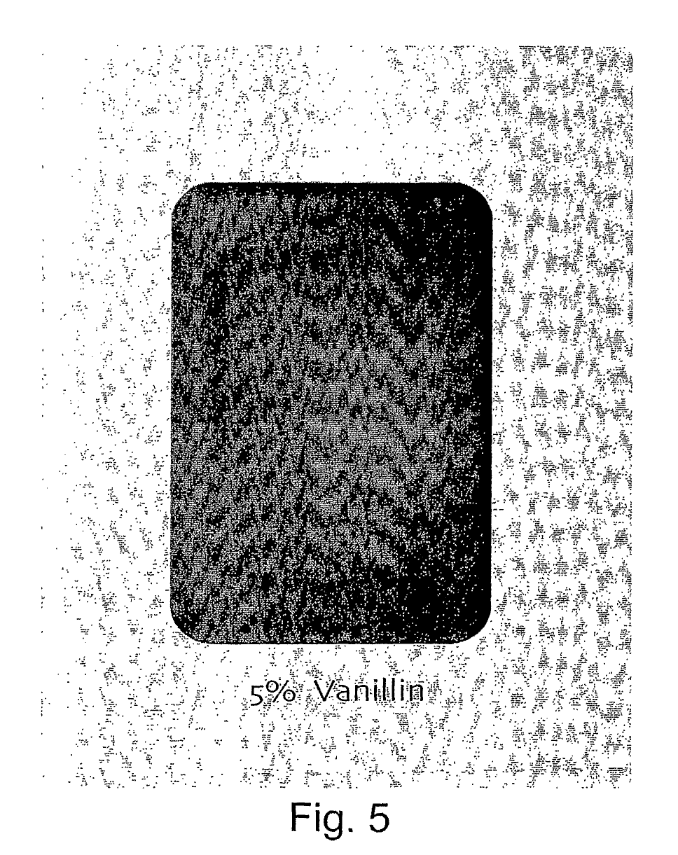

A glycerine soap base (obtained from http://www.meltandpoursupplies.com/bases.htm) was melted at about 65° C. The melted soap based was maintained at 60 to 80° C. and 5% by weight of vanillin was added. The mixture was stirred until the vanillin dissolved. The mixture was then allowed to cool to room temperature in a mould to produce a soap bar. The soap bar was stored on a shelf at room temperature in a light environment with no protection from the light for three weeks. A photograph of the soap bar after three weeks at room temperature is shown in FIG. 5.

### Comparative Example B

A glycerine soap base (obtained from http://www.meltandpoursupplies.com/bases.htm) was melted at about 65° C. The melted soap based was maintained at 60 to 80° C. and 1% by weight of ethylvanillin was added. The mixture was stirred until the ethylvanillin dissolved. The mixture was then allowed to cool to room temperature in a mould to produce a soap bar.

The soap bar was stored on a shelf at room temperature in a light environment with no protection from the light for three weeks. A photograph of the soap bar after three weeks at room temperature is shown in FIG. 6.

The Examples demonstrate that the use of a sulfiting agent with vanillin or ethylvanillin reduces/prevents the discoloration of soap bars containing the sulfiting agent and vanillin or ethylvanillin compared to the same soap bars which do not contain the sulfiting agent. The examples also demonstrate that the use of a sodium hydrogen sulfite adduct of vanillin or ethylvanillin reduces/prevents the discoloration of soap bars containing those adducts compared to the same soap bars containing vanillin or ethylvanillin in the absence of a sulfiting agent.

I claim:

1-24. (canceled)

25. A composition, preparation, formulation or article comprising an aromachemical subject to discoloration and an amount of a water-soluble sulfiting agent effective to stabilize said composition, preparation, formulation or article against discoloration.

26. A composition, preparation, formulation or article of claim 25 wherein said aromachemical is susceptible to discoloration as a result of its being converted to undesirable polymers and/or reaction products such as polyphenols.

27. A composition, preparation, formulation or article of claim 26 wherein the sulfiting agent is an alkali metal, ammonium or alkaline earth metal metabisulfite, sulfite, bisulfate or hydrosulfite, sulfur dioxide, an adduct of the sulfiting agent and said aromachemical or mixtures thereof.

28. A composition, preparation, formulation or article of claim 26, wherein the aromachemcial contains an aromatic group.

29. A composition, preparation, formulation or article of claim 26, wherein the aromachemcial contains a phenol ring and/or an Indole group.

30. A composition, preparation, formulation or article of claim 26, wherein the aromachemcial is indole, skatole, heliotropine, hydroeinnamaldehyde, alpha-methyl-3,4-(Inethylenedioxy) (Helional®), vanillin, straight or branched C₁-C₄ alkyl vanillins, methyl eugenol, methyl salicylate, benzyl salicylate, eugenol, iso-eugenol, methyl iso-eugenol or mixtures thereof.

31. A composition, preparation, formulation or article of claim 26, wherein the aromachemical is vanillin, ethyl vanillin, iso-eugenol or indole.

32. A composition, preparation, formulation or article of claim 26, wherein the aromachemical is vanillin.

33. A method for color-stabilizing an aromachemical that is subject to discoloration, the method comprising combining with the aromachemical an amount of water-soluble sulfiting agent sufficient to at least substantially reduce the discoloration thereof.

34. The method of claim 33 wherein said aromachemical is susceptible to discoloration as a result of its being converted to undesirable polymers and/or reaction products such as polyphenols.

35. The method of claim 34 wherein the sulfiting agent is an alkali metal, ammonium or alkaline earth metal metabisulfite, sulfite, bisulfite or hydrosulfite, sulfur dioxide, an adduct of the sulfiting agent and said aromachemical or mixtures thereof.

36. The method of claim 34, wherein the aromachemcial contains an aromatic group.

37. The method of claim 34, wherein the aromachemcial contains a phenol ring and/or an Indole group.

38. The method of claim 34, wherein the aromachemcial is indole, skatole, heliotropine, hydrocinnamaldehyde, alpha-methyl-3,4-(methylenedioxy) (Helionale), vanillin, straight or branched C₁-C₄ alkyl vanillins, methyl eugenol, methyl salicylate, benzyl salicylate, eugenol, iso-eugenol, methyl iso-eugenol or mixtures thereof.

39. The method of claim 34, wherein the aromachemical is vanillin, ethyl vanillin, iso-eugenol or indole.

40. The method of claim 34, wherein the aromachemical is vanillin.

41. A method for color-stabilizing a composition, preparation, formulation or article against discoloration, the composition, formulation, preparation or article of manufacture containing an aromachemical that is subject to discoloration, the method comprising combining with the composition, formulation, preparation or article of manufacture an amount of water-soluble sulfiting agent sufficient to at least substantially reduce the discoloration of said composition, preparation, formulation or article of manufacture.

42. The method of claim 41 wherein said aromachemical is susceptible to discoloration as a result of its being converted to undesirable polymers and/or reaction products such as polyphenols.

43. The method of claim 42 wherein the sulfiting agent is an alkali metal, ammonium or alkaline earth metal metabisulfite, sulfite, bisulfate or hydrosulfite, sulfur dioxide, an adduct of the sulfiting agent and said aromachemical or mixtures thereof.

44. The method of claim 42, wherein the aromachemical contains an aromatic group.

45. The method of claim 42, wherein the aromachemical contains a phenol ring and/or an Indole group.

46. The method of claim 42, wherein the aromachemical is indole, skatole, heliotropine, hydrocinnamaldehyde, alpha-methyl-3,4-(methylenedioxy) (Helional®), vanillin, straight or branched C₁-C₄ alkyl vanillins, methyl eugenol, methyl salicylate, benzyl salicylate, eugenol, iso-eugenol, methyl iso-eugenol or mixtures thereof.

47. The method of claim 42, wherein the aromachemical is vanillin, ethyl vanillin, iso-eugenol or indole.

48. The method of claim 42, wherein the aromachemical is vanillin.

49-56. (canceled)

57. A composition, preparation, founulation or article comprising an aromachemical that is subject to discoloration, an amount of a water-soluble sulfiting agent effective to at least substantially color-stabilize the composition, preparation, formulation or article of manufacture; and a suitable carrier for the sulfiting agent.

58. The composition of claim 58 wherein said aromachemical is susceptible to discoloration as a result of its being converted to undesirable polymers and/or reaction products such as polyphenols.

59. The composition of claim 58 wherein the sulfiting agent is an alkali metal, ammonium or alkaline earth metal metabisulfite, sulfite, bisulfate or hydrosulfite, sulfur dioxide, an adduct of the sulfiting agent and said aromachemical or mixtures thereof.

60. The composition of claim 58, wherein the aromachemcial contains an aromatic group.

61. The composition of claim 58, wherein the aromachemcial contains a phenol ring and/or an Indole group.

62. The composition of claim 58, wherein the aromachemcial is indole, skatole, heliotropine, hydrocinnamaldehyde, alpha-methyl-3,4-(methylenedioxy) (Helionale®), vanillin, straight or branched C₁-C₄ alkyl vanillins, methyl eugenol, methyl salicylate, benzyl salicylate, eugenol, iso-eugenol, methyl iso-eugenol or mixtures thereof.

63. The composition of claim 58, wherein the aromachemical is vanillin, ethyl vanillin, iso-eugenol or indole.

64. The composition of claim 58, wherein the aromachemical is vanillin.

65-71. (canceled)
